(19) United States
(12) Patent Application Publication
(10) Pub. No.: US 2013/0145624 A1
(43) Pub. Date: Jun. 13, 2013

(54) Personal-care appliance having pivoting fluid connector

(71) Applicants: Paul Michael Jessemey, Lambourn (GB); Kevin James Wain, Reading (GB)

(72) Inventors: Paul Michael Jessemey, Lambourn (GB); Kevin James Wain, Reading (GB)

(21) Appl. No.: 13/586,097

(22) Filed: Aug. 15, 2012

Related U.S. Application Data
(60) Provisional application No. 61/568,883, filed on Dec. 9, 2011.

(51) Int. Cl. B26B 21/44; B23P 11/00; A45D 44/00; B26B 21/52

(52) U.S. Cl. 30/41; 137/15.01; 137/315.01

(57) ABSTRACT

A fluid dispensing razor with a handle defining a cavity configured to receive a fluid reservoir. A fluid dispensing cartridge is mounted to the handle. A fluid connector is pivotably coupled to the handle. The fluid connector has a neutral position and a biased loading position. The fluid connector in the biased loading position is inclined at an angle of about 10 degrees to about 60 degrees relative to the fluid connector in the neutral position.

### CROSS REFERENCE TO RELATED APPLICATIONS

This application claims the benefit of U.S. Provisional application No. 61/568,883, filed Dec. 9, 2011.

### FIELD OF THE INVENTION

The present invention relates to personal-care appliances in general, and more particularly, to fluid dispensing shaving razors having a pivoting fluid connector.

### BACKGROUND OF THE INVENTION

Skin care can be of particular importance in improving or enhancing the appearance of men and women. Various products and methods can be used to care for skin For example, exfoliant scrubs, cleansers, and lotions are sometimes used to maintain healthy-looking skin. Exfoliant scrubs can be used to remove dead skin cells from the surface of the skin, which can give the skin an improved tone. Soaps and other cleansers can be used to remove dirt and excess oil from the skin, which can help prevent clogging of pores. Consequently, acne and other types of skin blemishes can be prevented in some cases. Lotions and various other topical ointments can also be used to deliver nutrients and/or moisturizers to the skin in an effort to improve the appearance and/or the health of the skin. Other types of cosmetic products (e.g., creams and lotions) or drug actives are sometimes used in an attempt to eliminate wrinkling and other signs of aging.

Various fluid dispensing personal care appliances have been developed to deliver lotions or other ointments to the body (e.g., skin or hair). Typically the fluid dispending personal care appliances include a handle that contains a pump and a container of fluid to be dispersed. Generally, the container of fluid utilizes the most of the space within the personal care appliances. There also must be sufficient space within the handle for a consumer to load and unload the container, which results in larger and more bulky designs. Furthermore, the loading and unloading of the container may be difficult and not intuitive to the consumer. The pump assemblies that have been developed are also complex and large in size, which limits the size of the fluid container that can be incorporated within the handle.

In the past, there have been a number of wet shaving product configurations that include a system for conveying a shaving preparation during shaving, e.g. a lubricating fluid, from a reservoir incorporated in the razor structure in the form of a hollowed out razor handle or even an aerosol can that acts as a razor handle, to a dispensing location near the head of the razor. A number of more recent wet shaving razors have cartridges that are movably mounted, in particular pivotable, relative to the handle structures on which they are mounted either permanently, in the case of disposable safety razors intended to be discarded when the blade or blades have become dulled, or detachably to allow replacement of the blade unit on a reusable handle structure. Many of these types of razors that are capable of conveying a fluid to the skin surface are unfortunately plagued by a number of problems. For instance, the innerworkings of the razors are complicated and tend to be cost prohibitive from a large scale manufacturing standpoint. Additionally, there are safety and performance issues that are constantly experienced due to microbial growth within the reservoir due to the continued exposure of a portion of the remaining fluid to air. This exposure of the fluid to air may oftentimes result in clogging of the razor's innerworkings by the fluid resulting in a nonperforming shaving product.

The hair removal process is known to cause certain irritations and discomfort for skin. Accordingly, desirable skin benefits may include soothing and moisturization. Soothing and moisturization are not typically achieved by a shaving razor by itself, but by a lotion or cream that is applied to the skin after shaving and after the shave gel has been removed from the skin. Regardless of whether the hair removal process is via a wet or dry shave, there is an ongoing need to provide certain personal care compositions to accompany or facilitate the hair removal process. Typically, the personal care composition is sold as a separate package.

### SUMMARY OF THE INVENTION

In one aspect, the invention features, in general, a fluid dispensing razor with a handle defining a cavity configured to receive a fluid reservoir. A fluid dispensing cartridge is mounted to the handle. A fluid connector is pivotably coupled to the handle. The fluid connector has a neutral position and a biased loading position. The fluid connector in the biased loading position is inclined at an angle of about 10 degrees to about 60 degrees relative to the fluid connector in the neutral position.

In another aspect, the invention features, in general, a fluid dispensing razor with a handle defining a cavity configured to receive a fluid reservoir. A fluid dispensing cartridge mounted to the handle. A fluid connector is pivotably coupled to the handle and releasably engaged to the fluid reservoir. The fluid reservoir has a loaded position and a release position. The fluid reservoir is positioned within the cavity in the loaded position and is pivoted outside of the cavity in the release position. The fluid reservoir is in fluid communication with the fluid connector in both the loaded position and the release position.

In another aspect, the invention features, in general, a method of loading a fluid reservoir for a fluid dispensing razor. A sealed fluid reservoir is provided. A handle defining a cavity configured to receive the fluid reservoir is provided. The handle has a fluid connector. The fluid connector is pivoted from a neutral position to a biased loading position that is inclined at about 10 degrees to about 60 degrees relative to the fluid connector in the neutral position. The fluid reservoir is pierced with the fluid connector. The fluid reservoir is engaged to the fluid connector.

The details of one or more embodiments of the invention are set forth in the accompanying drawings and the description below. It is understood that certain embodiments may combine elements or components of the invention which are disclosed in general, but not expressly exemplified or claimed in combination, unless otherwise stated herein. Other features and advantages of the invention will be apparent from the description and drawings, and from the claims.

### BRIEF DESCRIPTION OF THE DRAWINGS

FIG. 1A is a front view of one possible embodiment of a personal-care appliance.

FIG. 1B is a cross section view of the personal-care appliance, taken generally along the line 1B-1B of FIG. 1A.

FIG. 2 is an exploded side view of the personal-care appliance of FIG. 1A.

FIG. 3A is an enlarged side view of the personal-care appliance of 2A in a first position.

FIG. 3B is an enlarged side view of the personal-care appliance of 2A in a second position.

FIG. 3C is an enlarged side view of the personal-care appliance of 2A in a third position.

FIG. 4A is front view of a pump assembly that may be incorporated into the personal-care appliance of FIG. 1A.

FIG. 4B is a cross section view of the pump assembly, taken generally along the line 4B-4B of FIG. 4A.

FIG. 5 is a perspective view of a fluid connector that may be incorporated into the pump assembly of FIG. 4A.

FIG. 6A is an enlarged exploded view of a handle and the pump assembly of the personal-care appliance.

FIG. 6B is an enlarged view of the personal-care appliance.

### DETAILED DESCRIPTION OF THE INVENTION

The present disclosure is not limited to wet shaving razors, or even razors in general. It is understood that certain aspects of the present disclosure may also be used for dry electric shaving razors that have one or more rotating or reciprocating blades or other personal care appliances (e.g., toothbrushes, depilatory applicators, epilators, or other beauty applicators). Furthermore, it is understood that certain aspects of the present disclosure may be used independently for applying a fluid (e.g., to the skin or hair).

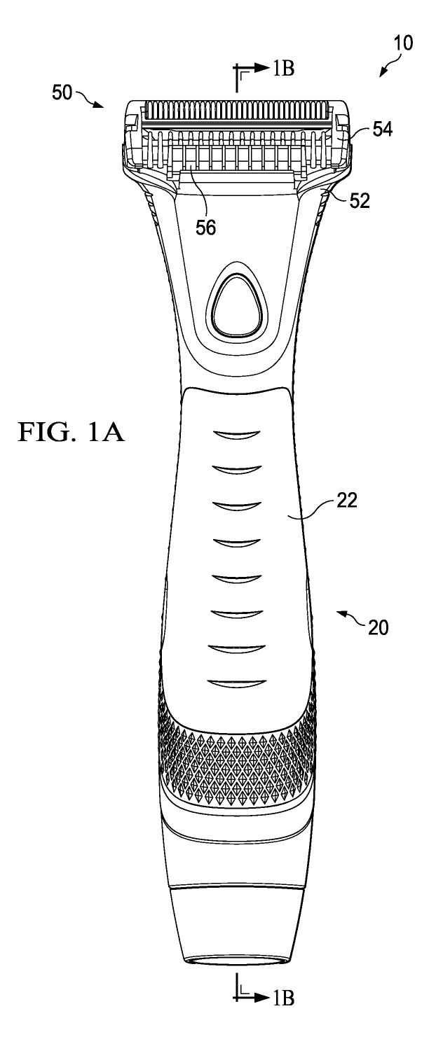

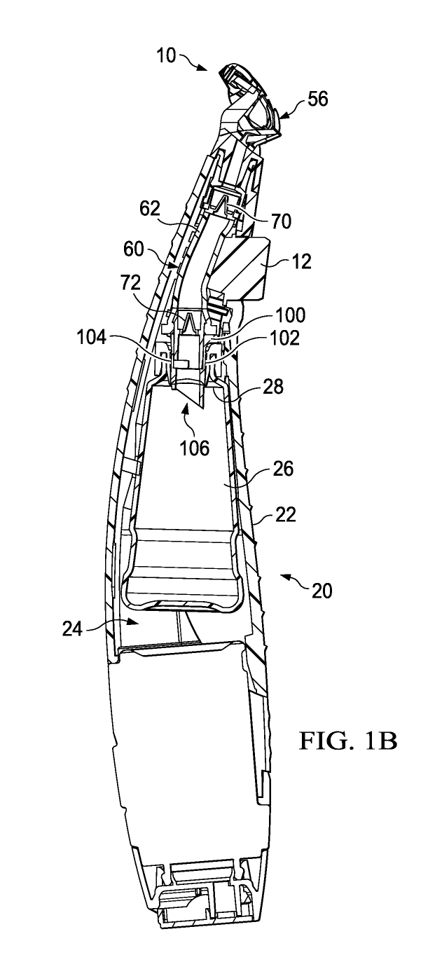

Referring to FIG. 1A, one possible embodiment of the present disclosure is shown illustrating a front view of a personal-care appliance 10. For example, the personal-care appliance may be a fluid dispensing razor (as shown), a toothbrush, a mascara brush, or any other personal-care appliance that dispenses a fluid. As will be described in greater detail below, the personal-care appliance 10 may include a handle 20 configured to receive a pump and a fluid reservoir (not shown). The handle 20 may have a cover 22 that protects and/or conceals the pump and/or fluid reservoir within the handle 20. A fluid dispensing cartridge 50 may be mounted (e.g., removable) to the handle 20. The fluid dispensing cartridge 50 may have a fluid connector 52 at one end that makes a mechanical and fluid connection to the handle 20. A cartridge housing 54 (e.g., a shaving razor cartridge) may be pivotably mounted to the other end of the removable fluid dispensing cartridge 50. The fluid dispensing cartridge 50 may include an applicator 56 to apply and spread the fluid to the surface to be treated (e.g., skin or hair). In certain embodiments, the personal-care appliance 10 may include a non-removable fluid dispensing cartridge, depending on desired final application of the personal care appliance.

Referring to FIG. 1B a cross section view of the personal-care appliance 10, taken generally along the line 1B-1B of FIG. 1A is shown. A fluid (e.g., a lotion or gel) may be held within a fluid reservoir 26. The handle 20 may define a cavity 24 configured to receive the fluid reservoir 26. The personal-care appliance 10 of FIG. 1B is shown with the fluid reservoir 26 within the cavity 24 in a final loaded position with the cover 22 mounted and secured to the handle 20. In certain embodiments, the fluid reservoir 26 may be a delaminating bottle or a satchet. In other embodiments, the fluid reservoir 26 may be a blow molded or injection molded plastic bottle. A fluid connector 100 may removably engage the fluid reservoir 26 to establish fluid connection. An outer surface 102 of the fluid connector 100 may seal against an inner wall 104 of the fluid reservoir 26 to prevent fluid from leaking into the handle 20. The fluid connector 100 may pierce a seal 28 of the fluid reservoir 26 to establish a fluid connection between the applicator 56 and the fluid reservoir 26. In certain embodiments, the seal 28 may be perforated to provide reliable and repeatable fluid connection. Accordingly, fluid is directed within an opening 106 of the fluid connector 100 which is in fluid communication with a pump assembly 60. The pump assembly 60 may include an elongated resilient tube 62 that pumps fluid from the fluid reservoir 26 through a pair of valves 70 and 72 to the applicator 56. When the fluid reservoir 26 is in the final loaded position, the fluid connector 100 may be in a first or neutral position in which the fluid connector 100 extends along an axis that is generally parallel to a longitudinal axis of the fluid reservoir 26.

The personal-care appliance may have an actuator 12 (e.g., a button) to facilitate pumping of the fluid from the fluid reservoir 26 to the applicator 56. The actuator 12 may compress the resilient elastomeric tube 62 to open the first valve 70 and release a predetermined dosage of fluid to the applicator 56. The actuator 12 may be released to return the resilient elastomeric tube 62 to its uncompressed state. The first valve 70 may close to prevent contamination and the second valve 72 may open to fill the resilient elastomeric tube 62 with fluid for the next release by the actuator 12. The actuator 12 may also facilitate pivoting of the fluid connector 100 for improved loading and unloading of the fluid reservoir 26. For example, the actuator 12 compressing the resilient elastomeric tube 62, may cause the resilient elastomeric tube 62 to flex and thus the fluid connector to pivot within the handle 20.

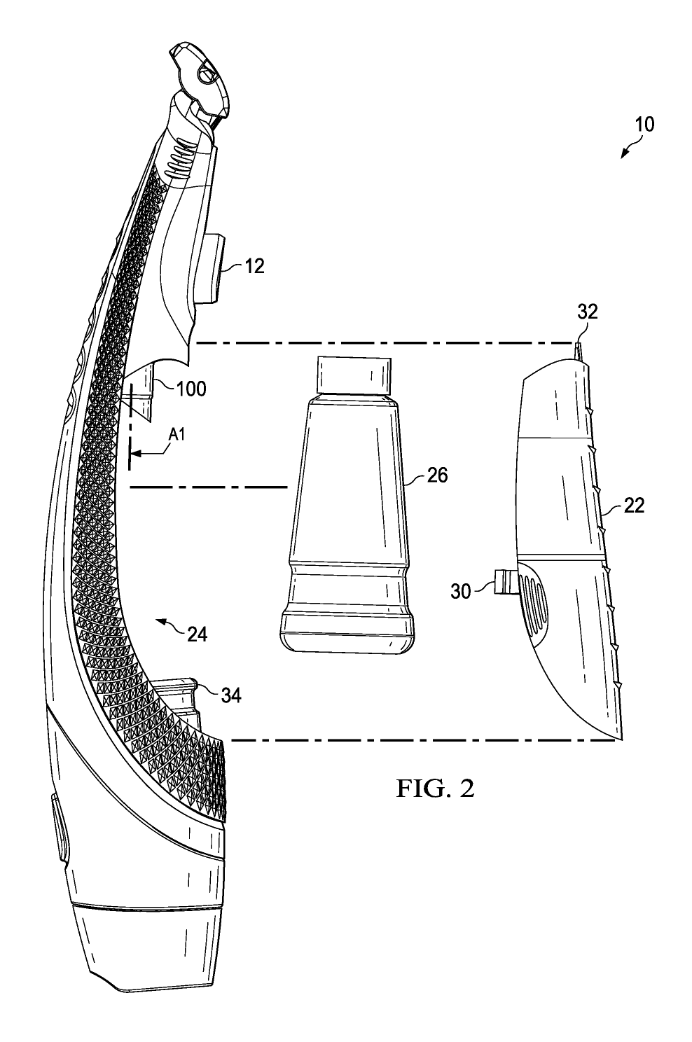

Referring to FIG. 2, an exploded side view of the personal-care appliance 10 is illustrated in an unloaded position with the cover 22 and the fluid reservoir 26 removed from the handle 20. The cover 22 may have one or more engagement members (e.g., tabs 30 and 32) to secure the cover 22 to the handle 20. The fluid connector 100 may be positioned within the cavity 24. In the unloaded position, the fluid connector 100 may be in the neutral position. In certain embodiments, the length of the fluid reservoir 26 may be greater than or equal to the distance between the fluid connector 100 and an end wall 34 of the cavity 24 to maximize the size of the fluid reservoir 26. Accordingly, it may be difficult to load and/or unload the fluid reservoir 26 from the cavity 24 without moving the fluid connector 100. In the neutral position, the fluid connector 100 may extend generally along an axis “A1”.

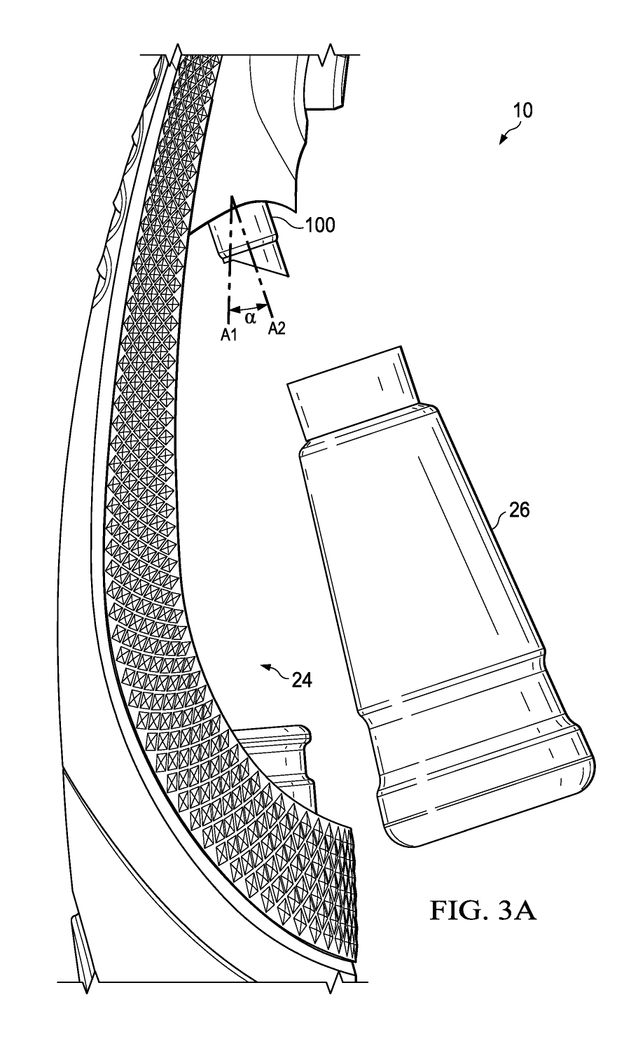

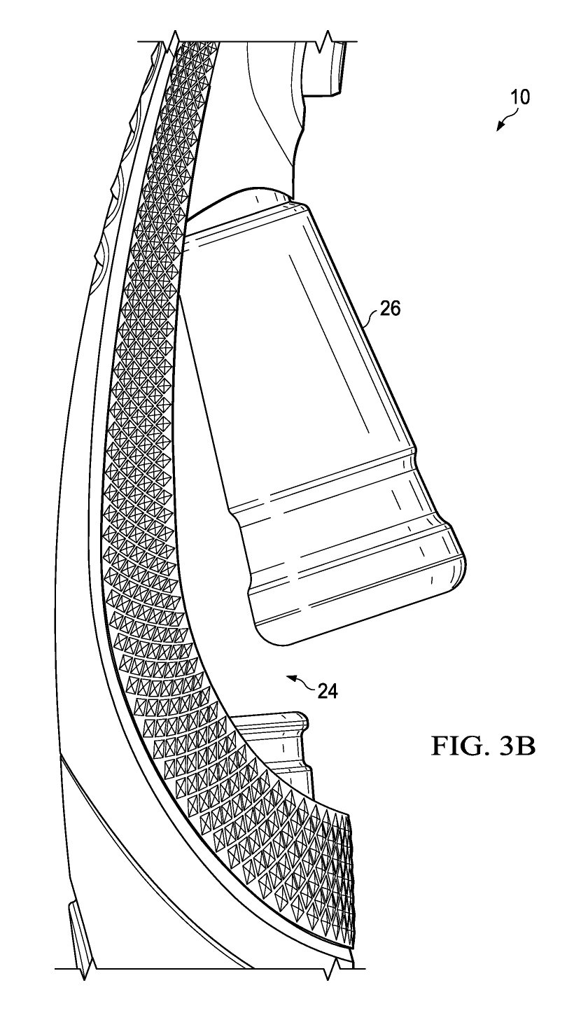

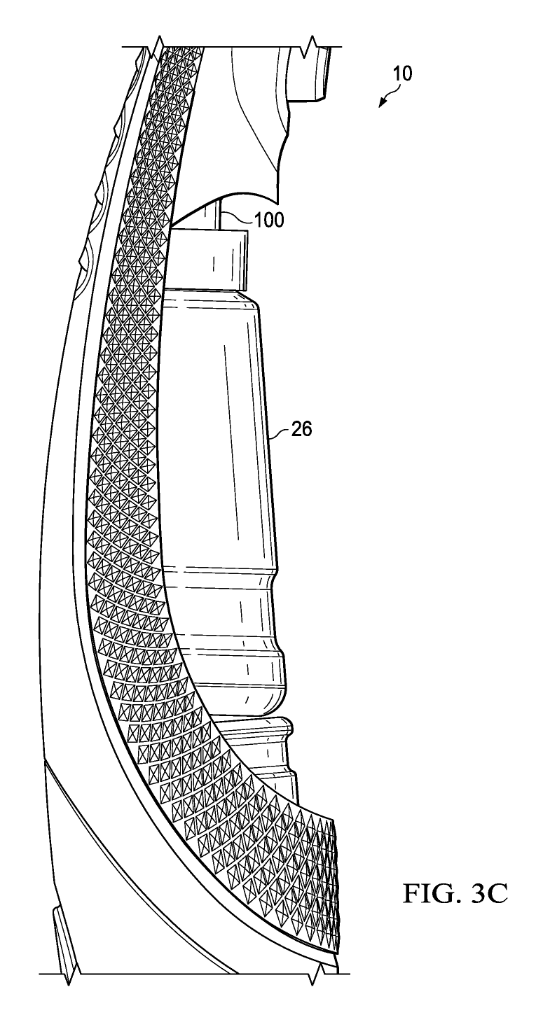

FIGS. 3A, 3B, and 3C are enlarged side views of the personal care appliance 10 representing various positions of the fluid connector 100 and the fluid reservoir 26. For example, referring to FIG. 3A, illustrates an enlarged side view of the personal-care appliance 10 with the fluid reservoir 26 in an unloaded position and the fluid connector 100 in a biased loading position. The fluid connector 100 may pivot relative to the handle 20 to facilitate the loading of fluid reservoir 26 within the cavity 24. In the biased loading position, the fluid connector 100 may extend generally along an axis “A2”. The axis A1 and the axis A2 may be non parallel, for example, the fluid connector may be inclined at an angle. In certain embodiments, the axis A2 of the fluid connector 100 may have an angle “α1” of about 10 degrees to about 60 degrees relative to the axis A1. In the biased loading position, the fluid connector 100 may engage the fluid reservoir 26 to establish a fluid connection, as shown in FIG. 3B. FIG. 3B illustrates the fluid connector 100 (and the fluid reservoir 26) in a biased loaded position with the fluid reservoir positioned outside of the cavity 24. The fluid connector 100 may be inserted into the fluid reservoir 26 to puncture a seal (not shown) of the fluid reservoir 26 and establish fluid connection. After the fluid reservoir 26 and the fluid connector 100 are engaged (i.e., loaded position), the fluid reservoir 26 may be pivoted to a final loaded position within the cavity 26 (as shown in FIG. 3C). The cover 22(not shown) may mounted and secured to the handle 20 to protect and/or conceal the fluid reservoir 26. The pivoting of the fluid connector 100 and the loading of the fluid reservoir 26 outside the cavity 24 of the handle improves accessability to load the fluid reservoir 26. The pivoting of the fluid connector 100 also provides improved access to the fluid reservoir 100 for removal of the fluid reservoir 26. For example, after the fluid within the fluid reservoir 26 is depleted, the actuator 12 may be pressed to facilitate the pivoting of the fluid connector 100 and/or fluid container from a position within the cavity 24 to a position outside the cavity 24 (e.g., the release position). The release position may be the same as the biased loaded position shown in FIG. 3B. When the fluid container 26 is in the released position, the consumer may easily remove the fluid reservoir 26.

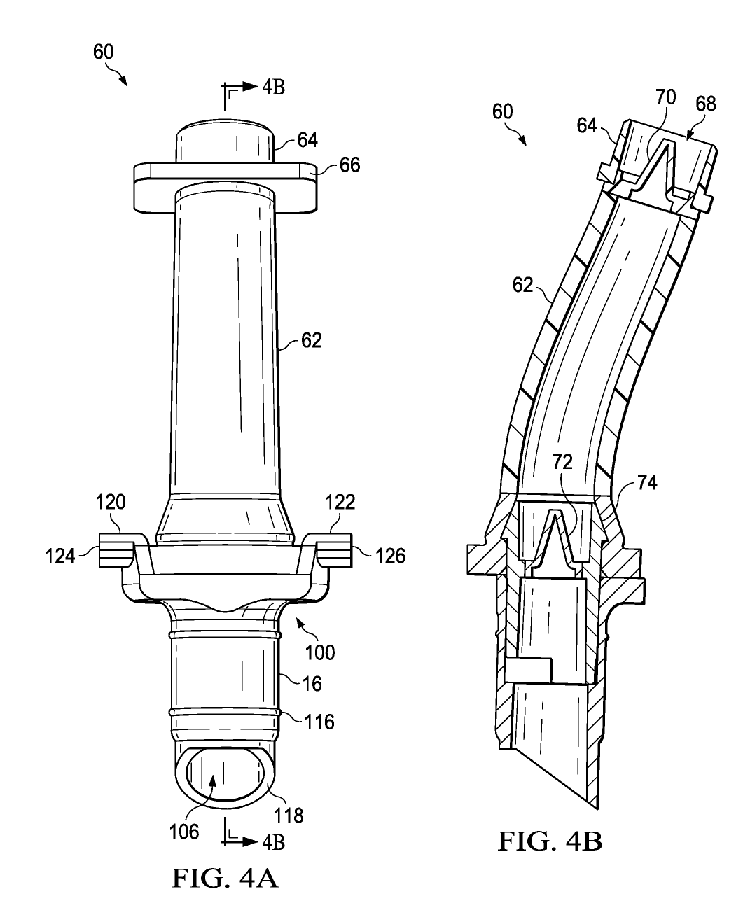

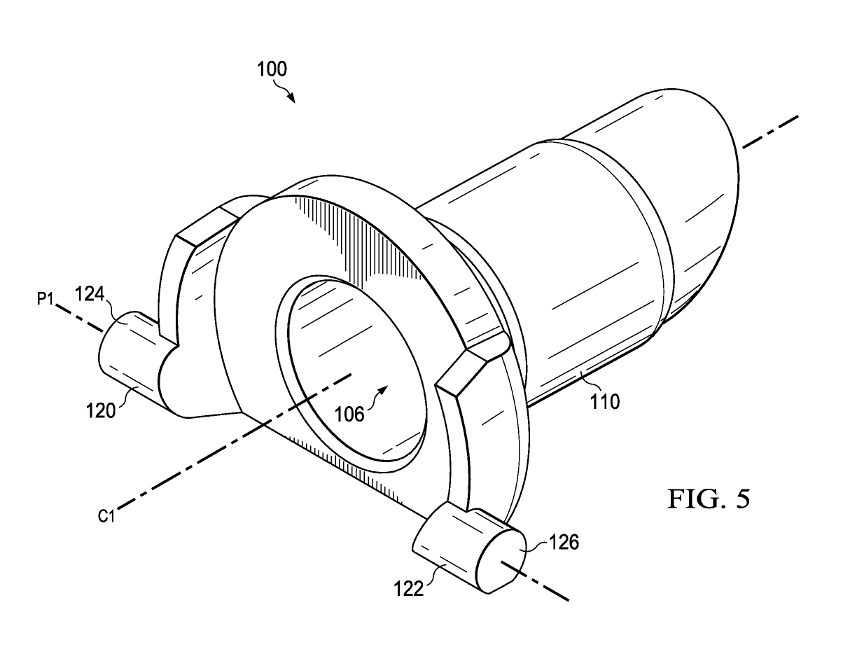

Referring to FIG. 4A, a bottom view of the pump assembly 60 is shown. The pump assembly 60 may include the resilient elastomeric tube 62. In certain embodiments, one end of the resilient elastomeric tube 62 may comprise a collar 64 having a flange 66. The collar 64 and/or the flange 66 may define an opening 68 dimensioned to receive the first seal 70. The collar 64 and/or the flange 66 may facilitate the mounting of the pump assembly 60 to the handle 20. The fluid connector 100 may be located at an end of the resilient elastomeric tube 62 opposite the collar 64 and/or the flange 66. The fluid connector 100 may include a barrel 110 that defines the opening 106 of the fluid connector 100. The barrel 110 may have an undercut 116 (e.g., a protrusion or a recess) that engages a corresponding undercut (e.g., a protrusion or a recess) of the fluid reservoir 26 (not shown). The undercut 116 of the barrel 110 and the fluid reservoir 26 may provide secure mechanical and fluid connection. Furthermore, the engagement of the undercuts may provide positive feedback (e.g., audible feedback) to the consumer signaling the fluid connector 100 is properly connected to the fluid reservoir 26. The barrel 110 may have a tip 106 with a bevel to pierce the seal of the fluid reservoir 26 (not shown). The barrel 110 may have one or more mating surfaces 120 and 122 (e.g., spaced apart pins 124 and 126) to facilitate pivoting of the fluid connector 100. In certain embodiments, the undercut 116 of the barrel 110 may engage the corresponding undercut of the fluid reservoir 26 during or after the seal is pierced signaling to the consumer the fluid reservoir 26 and the fluid connector 100 are in fluid communication.

FIG. 4B is a cross section view of the pump assembly 60, taken generally along the line 4B-4B of FIG. 4A. The resilient elastomeric tube 62 may be molded or extruded from a silicone or a thermoplastic elastomeric material. However, other resilient materials having a Shore A hardness (ISO 868) of about 20 to about 90 may be used including, but not limited to silicone, latex, polyvinylchloride (PVC), rubber, polyurethanes, any combination thereof. The resilient elastomeric tube 62 may comprise a material having a tensile strength at break of about 8 MPa, 9 MPa, or 10 MPa to about 12 MPa, 13 MPa, or 14 MPa (ISO 37). The resilient elastomeric tube 62 may comprise a material having a percent elongation at break of about 300% mm², 400%, or 500% to about 600% mm², 700%, or 800% (ISO 37). The resilient elastomeric tube 62 may have a nominal wall thickness of about 0.5 mm, 0.75 mm, or 1 mm to about 1.25 mm, 1 5 mm, or 2 mm to provide sufficient flexibility to allow efficient compression, but not too flexible such that the resilient elastomeric tube 62 does not return to its original position after being repeatedly compressed. In addition, the resilient properties of the resilient elastomeric tube 62 may facilitate the pivoting of the fluid connector 100.

In certain embodiments, the seals 70 and 72 may be molded from the same material as the resilient elastomeric tube 62. For example, the first or the second seal 70, 72 may be molded as part of the resilient elastomeric tube 62. For example, the collar 64 may be molded as part of the resilient elastomeric tube 62 (e.g., co-injection molding or insert injection molding) and the seal 70 may be molded inside of the collar 64. The collar 64 may be molded from a harder material than the resilient elastomeric tube 62 to provide improved engagement within the handle 20. The collar 64 may be joined to the resilient elastomeric tube 62 (e.g., press fitting, insert molding or co-injection molding). After molding the first seal 70 may be slit to provide fluid communication with the resilient elastomeric tube 62. The second seal 72 may also be molded from the same material as the resilient elastomeric tube 62 (e.g., silicone). The second seal 72 may be molded separately from the resilient elastomeric tube 62. For example, the second seal 72 may be molded and/or joined to a plug 74 that may be inserted into the resilient elastomeric tube 62. The second seal 72 may be co-injection molded, insert injection molded, or press fit to the plug 74. The second seal 72 may be slit before or after the plug 74 is inserted into the resilient elastomeric tube 62 to provide a fluid path. The plug 74 may be mounted to the fluid connector 100 or the plug 74 may comprise a portion of the fluid connector 100.

The seals 70 and 72 may be one way valves to prevent the fluid reservoir 26 from being contaminated. Examples of one way valves that may be used include, but not limited to ball check valves, swing check valves or tilting disc check valves, stop-check valves, lift-check valves, and duckbill valves. The positioning of the valves 70 and 72 within the elastomeric resilient tube 60 saves space and may also aid in preventing the seals 70 and 72 from moving out of position and leaking.

Referring to FIG. 5, a perspective view of the fluid connector 100 is shown. The opening 106 defined by the barrel 110 may extend completely through the barrel 110 to provide a fluid path. The fluid connector 100 may define a pivot axis “P1” that extends through a center of the spaced apart pins 124 and 126. The opening 106 and/or barrel 110 may have a center axis “C1”. In certain embodiments, the center axis C1 may extend in a transverse direction to the pivot axis P1. The pivot axis may also be off set (e.g., spaced apart) and/or not intersect the center axis of the opening 106 and/or barrel 110. The offset of the pivot axis and the center axis may facilitate the pivoting of the interconnect member 100 within the cavity 24 of the handle 20. In certain embodiments, the pivot axis P1 may be located below the center axis C1.

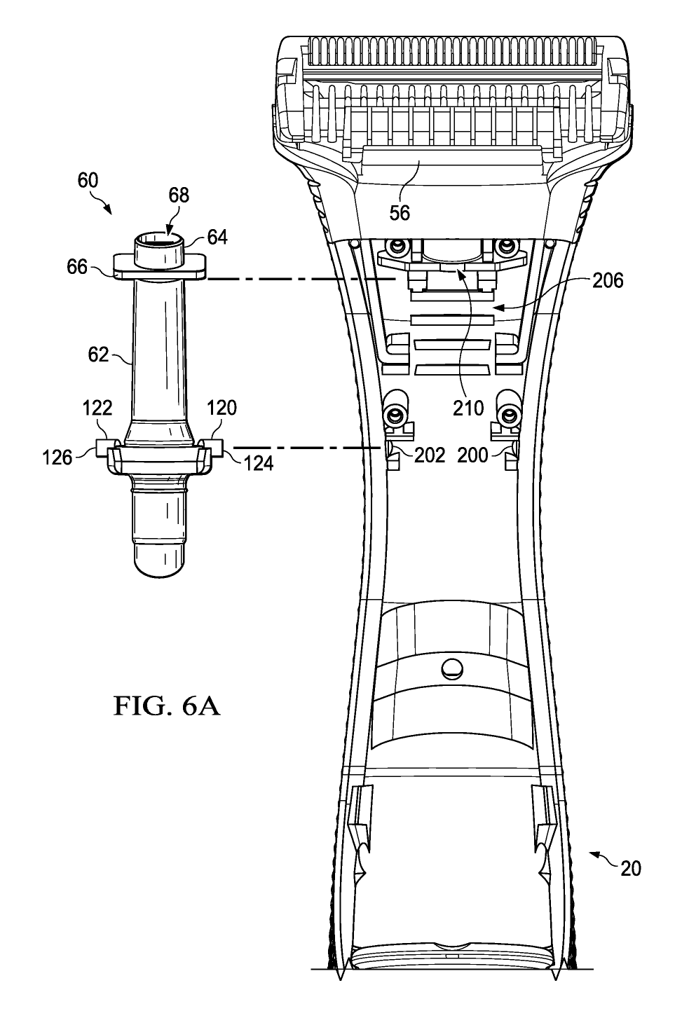

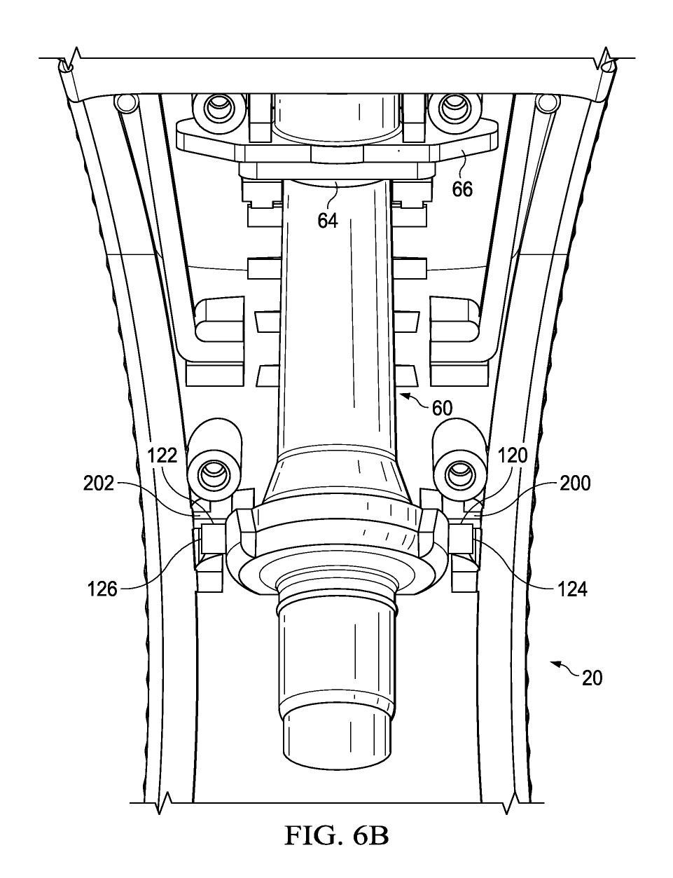

Referring to FIG. 6A, an exploded view is shown of the pump assembly 60 removed from the handle 20. The mating surfaces 120 and 122 of the fluid connector 100 may engage corresponding mating surfaces 200 and 202 of the handle 20. For example, the corresponding mating surfaces of the handle 20 may include recesses configured to receive the pin members 124 and 126 of the fluid connector. The collar 64 and/or flange 66 may engage a corresponding mating feature of the handle 20. The opening 68 of the collar 64 may be aligned with a fluid opening 210 defined by the handle 20, to establish a fluid connection with the applicator 56. Once the pump assembly 60 is properly assembled within the handle 20, the mating surface 120 and 122 of the fluid connector 100 may slidingly engage the corresponding mating surfaces 200 and 202 of the handle 20 to facilitate pivoting of the fluid connector 100. For example, a downward force may be applied to the resilient elastomeric tube 62 causing the resilient elastomeric tube 62 to flex and the mating surfaces 120 and 122 of the fluid connector 100 to slidingly engage the corresponding mating surfaces 200 and 202 of the handle 20.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ” Furthermore, dimensions should not be held to an impossibly high standard of metaphysical identity that does not allow for discrepancies due to typical manufacturing tolerances. Therefore, the term “about” should be interpreted as being within typical manufacturing tolerances.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A personal-care appliance for dispensing a fluid comprising:
a handle defining a cavity configured to receive a fluid reservoir;
a fluid dispensing cartridge mounted to the handle;
a fluid connector pivotably coupled to the handle, the fluid connector having a neutral position and a biased loading position wherein the fluid connector in the biased loading position is inclined at an angle of about 10 degrees to about 60 degrees relative to the fluid connector in the neutral position.

2. The personal-care appliance of claim 1 wherein the fluid connector defines an opening.

3. The personal-care appliance of claim 1 wherein the fluid connector has a mating surface that slidingly engages a corresponding mating surface of the handle to facilitate pivoting of the fluid connector relative to the handle.

4. The personal-care appliance of claim 3 wherein the mating surface of the fluid connector defines a pivot axis of the fluid connector.

5. The personal-care appliance of claim 3 wherein the mating surface of the fluid connector comprises a pair of spaced apart pins.

6. The personal-care appliance of claim 4 wherein fluid connector comprises a barrel having a center axis that is off set and transverse to the pivot axis of the fluid connector.

7. The personal-care appliance of claim 6 wherein the barrel defines an opening.

8. The personal-care appliance of claim 7 wherein a first end of the fluid connector has a bevel tip.

9. A fluid dispensing razor comprising:
a handle defining a cavity configured to receive a fluid reservoir;
a fluid dispensing cartridge mounted to the handle;
a fluid connector pivotably joined to the handle and releasably engaged to the fluid reservoir; and
the fluid reservoir having a loaded position and a release position, wherein the fluid reservoir is positioned within the cavity in the loaded position and is pivoted outside of the cavity in the release position and the fluid reservoir is in fluid communication with the fluid connector in both the loaded position and the release positions.

10. The fluid dispensing razor of claim 9 wherein the fluid reservoir in the release position is inclined at an angle of about 10 degrees to about 60 degrees relative to the fluid reservoir in the loaded position.

11. The fluid dispensing razor of claim 9 wherein a first end of the fluid connector pierces a seal of the fluid reservoir to establish fluid connection.

12. The fluid dispensing razor of claim 11 wherein the first end of the fluid connector has a bevel tip.

13. The fluid dispensing razor of claim 9 wherein an opposing end of the fluid connector is joined to a flexible tube.

14. The fluid dispensing razor of claim 9 wherein the fluid connector has a mating surface that slidingly engages a corresponding mating surface of the handle.

15. The fluid dispensing razor of claim 14 wherein the mating surface of the fluid connector defines a pivot axis of the fluid connector.

16. The fluid dispensing razor of claim 15 wherein the mating surface of the fluid connector comprises a pair of spaced apart pins.

17. The fluid dispensing razor of claim 15 wherein fluid connector comprises a barrel having a center axis that is off set and transverse to the pivot axis of the fluid connector.

18. The fluid dispensing razor of claim 17 wherein the barrel defines an opening.

19. A method of loading a fluid reservoir for a fluid dispensing razor comprising:
providing a sealed fluid reservoir;
providing a handle defining a cavity configured to receive the fluid reservoir, the handle having a fluid connector;
pivoting the fluid connector from a neutral position to a loading position that is inclined at about 10 degrees to about 60 degrees relative to the fluid connector in the neutral position;
piercing the fluid reservoir with the fluid connector; and
engaging the fluid reservoir to the fluid connector.

20. The method of loading a fluid reservoir for a fluid dispensing razor of claim 19 wherein said engaging includes snap fitting an undercut of the fluid connector with a corresponding undercut of the fluid reservoir.
